(19) United States
(12) Patent Application Publication
(10) Pub. No.: US 2018/0003968 A1
(43) Pub. Date: Jan. 4, 2018

(54) HEAD-UP DISPLAY WITH SIDE IMAGE GENERATOR

(71) Applicant: VALEO COMFORT AND DRIVING ASSISTANCE, Créteil (FR)

(72) Inventors: Pierre Mermillod, Créteil (FR); François Grandclerc, Créteil (FR)

(73) Assignee: VALEO COMFORT AND DRIVING ASSISTANCE, Créteil (FR)

(21) Appl. No.: 15/532,648

(22) PCT Filed: Dec. 4, 2015
(86) PCT No.: PCT/FR2015/053337

§ 371 Date: Jun. 2, 2017

(30) Foreign Application Priority Data
Dec. 5, 2014 (FR) 1402783

(51) Int. Cl. G02B 27/01; G02B 27/09

(52) U.S. Cl. CPC G02B 27/0101; G02B 27/0977; G02B 27/0149; G02B 2027/013; G02B 2027/0161; G02B 2027/0123

(57) ABSTRACT

The invention relates to a head-up display (1) with a side image generator (2), particularly for motor vehicle. Said head-up display comprises:—an image generator (2) configured to display an image along a display axis (7);—a semi-reflective optical element (3) arranged space apart from the image generator (2) and configured o display a virtual image along a projection axis (9); and—at least one mirror (4) arranged on the display axis (7) so as to reflect the image from the image generator (2) towards the optical element (3) along a reflection axis (8). The display axis (7) of the image generator (2) is perpendicular to the projection axis (9) of the optical element.

The present invention relates to a head-up display with side image generator, notably for a motor vehicle.

Head-up displays usually have the function of superimposing information providing assistance for flying, navigation or the execution of a mission in the field of view of an aircraft pilot, for example. The display thus enables the pilot to monitor his environment while also reading the information provided by his on-board instruments. These displays are now also used in motor vehicles.

Such a display comprises an image generator and a semi-reflective optical element configured to form a virtual image of the image from the generator. The virtual image is superimposed on the environment in the field of view of the driver or pilot. It is also possible to use the windshield of the vehicle as a semi-reflective optical element for forming the virtual image. The technical characteristics of such a display are concerned, notably, with the position of the optical element relative to the road and to the driver, and also with the angle of incidence of the image on the optical element, the aim being, notably, to avoid problems of distortion.

Known image generators in motor vehicles comprise one or more light sources and a pixel matrix which receives the light beam from the sources. The matrix transmits or reflects the light beam, producing an image which is formed by means of the pixels. Each pixel is individually controlled, and may have a position called “open”, in which the incident light forms part of the image, or a position called “closed”, in which the incident light does not form part of the displayed image. Thus an image is created on the basis of the open pixels. It is also possible to use laser scanning as a means of forming images.

There are different types of matrix, notably transistor matrices of the TFT type (for “Thin Film Transistor” in English), which operate by light transmission; that is to say, the light beam from the sources passes through the matrix, which is arranged between the light source and the optical element. There are also known matrices of the LCOS type (for “Liquid Crystal on Silicon” in English), and micro-mirror matrices of the DMD type (for “Digital Micro-Mirror Device” in English), which operate by reflecting the light beam toward the optical element.

In simple terms, the display device is arranged in the vehicle as follows: the image generator is positioned in the instrument panel with a mirror which reflects the image toward the semi-reflective optical element. The optical element is arranged on the instrument panel at the level of the windshield so as to be in the driver's field of view.

The display device is arranged in such a way that the image is presented substantially facing the optical element. In other words, the image is displayed or reflected substantially in the axis of the reflection surface of the optical element. The image generator must also be positioned at a minimum distance from the optical element to ensure that the virtual image is of a sufficient size, given that, on the one hand, the size of the matrices is limited, while on the other hand the virtual image must appear at about two meters from the driver. This arrangement of the display device therefore occupies a fairly large volume in the thickness of the instrument panel.

However, some vehicles have instrument panels into which such a display cannot be fitted. This is because goods vehicles, for example, are subject to regulatory constraints on their dimensions, notably their length, which therefore restrict the dimensions of their cabins, making it necessary to design instrument panels which are thinner than the instrument panels of private automobiles. Driving and comfort display systems for such a cabin are therefore designed specially for a limited instrument panel, which cannot accommodate an additional head-up display of this type.

The invention is therefore intended to provide a head-up display whose arrangement and dimensions are compatibles with thinner instrument panels.

For this purpose, the invention relates to a head-up display with side image generator, notably for a motor vehicle, comprising:
an image generator configured to display an image on a display axis,
a semi-reflective optical element arranged at a distance from the image generator and configured to cause a virtual image of the image to appear on an axis of projection, and
at least one mirror arranged on the display axis so as to reflect the image from the image generator toward the optical element along an axis of reflection.

The display is remarkable in that the display surface of the image generator is substantially parallel to a plane defined by the optical axis of projection and the optical axis of reflection.

Thus, because of this display, the image generator is not positioned in the axis of the optical element, but laterally, on the side. The display therefore has little depth, enabling it to be fitted into instrument panels which are thin, or which are already filled with electronic or mechanical elements, as in the cabins of goods vehicles for example.

Furthermore, this makes it unnecessary to design complex mirror displays which reflect the image in the axis of the optical element, with problems of loss of image quality and energy.

According to different embodiments of the invention, which may be considered separately or in combination:
the image generator is configured to form a substantially rectangular image, the longer side of which is substantially parallel to the optical axis of reflection,
the mirror is arranged substantially below the optical element,
the image generator, the optical element and the mirror are arranged in such a way that the plane of the mirror is substantially at 45° to the display surface,
the optical element lies at an angle of inclination relative to the axis of reflection of the mirror,
the mirror and the optical element are arranged in such a way that the axis of reflection is oriented substantially toward the center of the optical element,
the image generator comprises at least one light source capable of emitting a light beam, and a pixel matrix configured to display the image on the basis of the light beam,
the optical element is a semi-reflective blade,
the optical element is at least a part of a vehicle windshield,
the optical element has a curvature such that it provides at least some of the optical power required to form the virtual image,
the optical element is flat,
the mirror has a curvature such that it provides at least some of the optical power required to form the virtual image,
the mirror is flat.

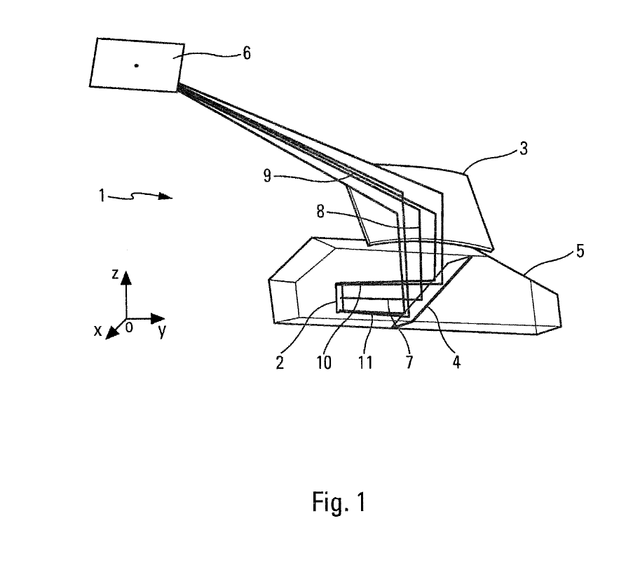

The invention will be more readily understood on consideration of the following description which is provided for guidance only and without limiting intent, accompanied by the appended drawing of FIG. 1, which shows schematically a perspective view of an embodiment of a display according to the invention.

FIG. 1 shows a head-up display 1, for example a display in a motor vehicle, in an orthonormal reference frame (O, x, y, z) where (Ox) and (Oy) are horizontal axes and (Oz) is a vertical axis. The display 1 is arranged at least partially in a housing or module 5, and comprises an image generator 2, arranged laterally and configured to display an image on a display surface in the plane (xOz). The term “lateral” is taken to mean that the image generator 2 is positioned at the side of the other elements of the display, and therefore is not in the axis as it would be in a conventional display. The image generator 2 comprises at least one light source capable of emitting a light beam, and a pixel matrix configured to form an image on the basis of the light beam. The light sources (not shown) are, for example, light-emitting diodes which are positioned in a part of the generator. The generator 2 comprises the pixel matrix, of the TFT type for example, on an output face of the generator 2. Thus the diodes emit a beam toward the matrix, which produces an image by transmission on a face of the image generator 2.

The image is displayed parallel to the plane (xOz) on an optical display axis 7 parallel to (Oy). In other words, the image is substantially centered on the optical display axis 7, which is substantially horizontal in this case. The display 1 also comprises a semi-reflective optical element 3, arranged at a distance from the image generator 2 and configured to cause a virtual image of the image from the generator 2 to appear.

In this case, the optical element 3 is a semi-reflective blade which is arranged on the module 5, and which may preferably be folded back onto the module 5 in a stowed position, or raised in a position of use.

The semi-reflective optical element 3 enables an observer to see the virtual image formed by reflection, while simultaneously seeing through the optical element 3. Thus, for an observer located at one side of the optical element 3, the virtual image is superimposed, in his field of view, on the environment seen through the optical element 3. The virtual image appears at a certain distance from the optical element 3 and hence from the observer. The virtual image is also substantially centered on an optical axis of projection 9 which passes through the center of the optical element 3. The optical axis of projection 9 is parallel to the plane (xOz), and the semi-reflective optical element 3 may have different inclinations, thus modifying the direction of the optical axis of projection 9 in the same plane.

The image generator 2 is configured to form a substantially rectangular image. The image is formed by the image generator 2 in such a way that the longer side of the image is substantially perpendicular to the optical axis of projection 9 of the virtual image. The longer side of the image is parallel to the axis (Oz), and is therefore vertical in this case. For this purpose, the pixel matrix is rectangular, and the image generator 2 is positioned in such a way that the longer side of the pixel matrix is substantially perpendicular to the optical axis of projection 9 of the virtual image. In other words, the display surface of the generator 2 is in a vertical position to provide a vertical image. This position of the generator 2 also allows the display 1 to be made more compact along the axis (Ox).

The display 1 is also arranged so that the optical display axis 7 of the image generator 2 is perpendicular to the optical axis of projection 9 of the virtual image.

For this purpose, the image generator 2 is positioned laterally at a distance from the optical element 3, and a mirror 4 is arranged substantially below the optical element 3, on the image display axis 7, so as to be on its optical path. Thus the mirror 4 reflects the image displayed by the image generator 2 toward the optical element 3 which is located above, on an optical axis of reflection 8 which is parallel to (Oz) and is therefore vertical in this case. In the drawing, the image generator 2 is shown on the left of the mirror, but it could equally well be on the right.

According to the invention, the display surface of the image generator 2 is substantially parallel to a plane defined by the optical axis of projection 9 and the optical axis of reflection 8. These two planes are therefore parallel to the plane (xOz).

The mirror 4 and the optical element 3 are arranged in such a way that the optical element 3 lies at an angle of inclination relative to the axis of reflection 8 of the mirror, and that the optical axis of reflection 8 is oriented substantially toward the center of the optical element 3, so as to minimize the problems of distortion.

The image generator 2 is preferably positioned at the same height as the mirror 4, and the mirror 4 is oriented so that the optical display axis 7 of the image is perpendicular to the optical axis of reflection 8 of the mirror 4. In other words, the generator 2, the mirror 4 and the optical element 3 are substantially positioned at the three corners of a right triangle parallel to the plane (yOz), the mirror 4 being arranged at the right angle. The plane of the mirror 4 is therefore substantially at 45° to the display surface of the generator 2.

The optical axes of display 7 and reflection form the two perpendicular sides of the right triangle. In this configuration, the vertically displayed image is reflected by the mirror 4 toward the optical element 3, in such a way that it is rotated through 90° after reflection toward the optical element 3. The longer side of the image is then parallel to the axis (Oy). In other words, the longer side of the rectangular image becomes horizontal after reflection from the mirror 4. Thus the virtual image also appears horizontal.

FIG. 1 shows rays representing the optical path of the four corners of the image in the display 1, to illustrate the 90° rotation of the image. The two pairs 10, 11 of rays from the corners of the two smaller sides of the image are horizontally parallel to the output of the image generator 2, then become vertically parallel after reflection from them mirror 4. Thus, the image that was vertical becomes horizontal. Furthermore, the virtual image formed by the optical element 3 is also substantially horizontal.

As shown in FIG. 1, the virtual image formed by the optical element 3 can be viewed by an observer in a window 6. In other words, in order to observe the image via the optical element 3, the observer must be positioned so that his eyes are in this window 6, called the “eye box”. The window is substantially centered on the optical axis of projection 9.

In another embodiment of the display, which is used in a vehicle, part of the windshield acts as a semi-reflective optical element. For this purpose, the rest of the display is arranged in the instrument panel so that the windshield can be used as a semi-reflective optical element.

Additionally, at least one of the elements of the display 1 is configured to provide an optical power in order to cause the virtual image to appear at a certain distance from the optical element 3 and with a specific magnification. Thus it is correctly superimposed on the environment appearing in the observer's field of view. The optical power is a physical characteristic, which determines the capacity of an optical system to cause light to converge or diverge. It is equal to the ratio between the angle at which the eye views the image output by the system and the size of the object.

In a first variant embodiment, shown in FIG. 1, the mirror 4 is flat and the optical element 3 has a curvature which provides the optical power.

In a second variant embodiment, not shown in the drawing, it is the mirror 4 that is curved, and the optical element 3 is flat.

In a third variant embodiment, not shown, the optical element 3 and the mirror 4 each have curvatures such that they each provide part of the optical power, in a complementary manner.

1. A head-up display with a side image generator for a motor vehicle, comprising:
an image generator configured to display an image on a display surface;
a semi-reflective optical element arranged at a distance from the image generator and configured to cause a virtual image of the image to appear on an optical axis of projection; and
at least one mirror arranged so as to reflect the image from the image generator toward the optical element along an optical axis of reflection,
wherein the display surface of the image generator is substantially parallel to a plane defined by the optical axis of projection and the optical axis of reflection.

2. The display as claimed in claim 1, wherein the image generator is configured to form a substantially rectangular image, the longer side of which is substantially parallel to the optical axis of reflection.

3. The display as claimed in claim 1, wherein the mirror is arranged substantially below the optical element.

4. The display as claimed in claim 1, wherein the image generator, the optical element and the mirror are arranged so that the plane of the mirror is substantially at 45° to the display surface.

5. The display as claimed in claim 1, wherein the optical element lies at an angle of inclination relative to the axis of reflection of the mirror.

6. The display as claimed in claim 1, wherein the mirror and the optical element are arranged so that the axis of reflection is oriented substantially toward the center of the optical element.

7. The display as claimed in claim 1, wherein the image generator comprises at least one light source capable of emitting a light beam, and a pixel matrix configured to display the image on the basis of the light beam.

8. The display as claimed in claim 1, wherein the optical element is a semi-reflective blade.

9. The display as claimed in claim 1, wherein the optical element is at least a part of a vehicle windshield.

10. The display as claimed in claim 1, wherein the optical element has a curvature such that the optical element provides at least a portion of the optical power required to form the virtual image.

11. The display as claimed in claim 1, wherein the optical element is flat.

12. The display as claimed in claim 1, wherein the mirror has a curvature such that the mirror provides at least a portion of the optical power required to form the virtual image.

13. The display as claimed in claim 1, characterized in that the mirror is flat.
